(19) United States
(12) Patent Application Publication
(10) Pub. No.: US 2026/0183725 A1
(43) Pub. Date: Jul. 2, 2026

(54) FLUID DELIVERY AND MIXING NOZZLE

(71) Applicant: SOLENIS TECHNOLOGIES, L.P., Wilmington, DE (US)

(72) Inventors: Brett Brotherson, Avondale, PA (US); Sachin Borkar, Wilmington, DE (US)

(73) Assignee: SOLENIS TECHNOLOGIES, L.P., Wilmington, DE (US)

(21) Appl. No.: 19/373,865

(22) Filed: Oct. 30, 2025

Related U.S. Application Data
(60) Provisional application No. 63/714,169, filed on Oct. 31, 2024.

(51) Int. Cl. B01F 25/10; B05B 7/24

(52) U.S. Cl. CPC B01F 25/104; B05B 7/24; B01F 2215/0422

(57) ABSTRACT

A fluid mixing nozzle includes a body with a sidewall with an inner surface defining a vortex chamber. The inner surface defines an inlet opening having a flow path of a first fluid entering the vortex chamber through the inlet opening. The body forms an outlet of the vortex chamber. A core is disposed within the body, forms an annular space within the vortex chamber, and has an outwardly facing core surface spaced from, and facing, the inner surface to define the annular space between the core surface and the inner surface. A core channel extends through the core and has at least one channel entrance and at least one channel exit. The at least one channel entrance is disposed at least partially within the flow path. The at least one channel exit fluidly communicates with the vortex chamber. At least one mixing section communicates with the outlet.

### CROSS-REFERENCE TO RELATED PATENT APPLICATION

This application claims the benefit of U.S. Provisional Patent Application No. 63/714,169, filed October 31, 2024, and which is incorporated herein for all purposes.

### TECHNICAL FIELD

The present disclosure generally relates to fluid mixing and delivery, and more particularly relates to nozzles with mixing chambers.

### BACKGROUND

Many industries combine chemical components to produce a mixed stream such as for papermaking, water treatment, and many others. Conventional mixing nozzles used to form these mixed streams attempt to provide a discharged or end product with a desired energy, flow rate, and pressure. Difficulties occur when the structure of the flow path within the nozzle develop undesired or insufficient flow paths that cause cavitation in vortex chambers as well as undesired fluid properties throughout the nozzle resulting in low flow-rates, low energy, and/or low pressure. These low level fluid properties, in turn, result in insufficient contact between the chemical components to achieve efficient mixing, whether due to the wrong amounts of the chemical components being in contact, the flow paths of the chemical components, and/or the interaction time of the mixture being too short or too long. Hence, a nozzle is desired that provides better flow path control of the chemical components being mixed together within the nozzle.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one implementation, a fluid mixing nozzle includes a body with a sidewall with an inner surface defining a vortex chamber. The inner surface defines an inlet opening having a flow path of a first fluid entering the vortex chamber through the inlet opening. The body forms an outlet of the vortex chamber. A core is disposed within the body and forms an annular space within the vortex chamber. The core comprises an outwardly facing core surface spaced from, and facing, the inner surface to define the annular space between the core surface and the inner surface. A core channel extends through the core and has at least one channel entrance and at least one channel exit. The at least one channel entrance is disposed at least partially within the flow path. A mixing section is defined by the body and has a first fluid inlet fluidly communicating with the outlet and at least one second fluid inlet to provide a second fluid within the mixing section.

In another implementation, a mixing nozzle device includes a body with a sidewall with an inner surface defining a vortex chamber. The inner surface defines an inlet opening having a flow path of a first fluid entering the vortex chamber through the inlet opening. The body forms an outlet of the vortex chamber. A core is disposed within the body and forms an annular space within the vortex chamber, while the core includes an outwardly facing core surface spaced from, and facing, the inner surface to define the annular space between the core surface and the inner surface. A core channel extends through the core and has at least one channel entrance and at least one channel exit. The at least one channel entrance faces sideways toward the inlet opening and is disposed at least partially within the flow path and across the annular space from the inlet opening. The core channel curves to point the channel exit downward, and the at least one channel exit fluidly communicates with the vortex chamber. A mixing section defined by the body has a first fluid inlet fluidly communicating with the outlet and at least one second fluid inlet to provide a second fluid within the mixing section.

In yet another implementation, a fluid delivery and mixing system includes at least first and second feed conduits providing first and second fluids respectively to be mixed. A nozzle with a body has a sidewall with an inner surface defining a vortex chamber, and the inner surface defines an inlet opening of the first feed conduit and having a flow path of the first fluid entering the vortex chamber through the inlet opening. The body forms an outlet of the vortex chamber. A core is disposed within the body and forms an annular space within the vortex chamber. The core comprises an outwardly facing core surface spaced from, and facing, the inner surface to define the annular space between the core surface and the inner surface. A core channel extends through the core and has at least one channel entrance and at least one channel exit. The at least one channel entrance is disposed at least partially within the flow path. The at least one channel exit fluidly communicates with the vortex chamber. A sidewall of the body defines a mixing section having a junction portion fluidly communicating with the outlet and having at least one second fluid inlet to receive a second fluid within the junction portion.

Furthermore, other desirable features and characteristics of the device and system will become apparent from the subsequent detailed description and the appended claims, taken in conjunction with the accompanying drawings and the preceding background.

### BRIEF DESCRIPTION OF THE DRAWINGS

Implementations of the subject matter will hereinafter be described in conjunction with the following drawing figures, wherein like numerals denote like elements, and:

FIG. 1 is a schematic diagram of a front and right side perspective view of a mixing nozzle according to at least one of the implementations described herein;

FIG. 2 is a schematic diagram of a front elevational view of the mixing nozzle of FIG. 1 and according to at least one of the implementations described herein;

FIG. 3 is a schematic diagram of a back cross-sectional view of the mixing nozzle of FIG. 1 and according to at least one of the implementations described herein;

FIG. 4 is a schematic diagram of a left side cross-sectional view of a vortex chamber of the mixing nozzle of FIG. 1 and according to at least one of the implementations described herein;

FIG. 5 is a schematic diagram of an upper cross-sectional view of the mixing nozzle of FIG. 1 and according to at least one of the implementations described herein;

FIG. 6 is a schematic diagram of a front and right side cross-sectional view of the mixing nozzle of FIG. 1 and according to at least one of the implementations described herein;

FIG. 7 is a schematic diagram of a right side cross-sectional view of the mixing nozzle of FIG. 1 and according to at least one of the implementations described herein;

FIG. 8 is a schematic diagram of a right perspective view of another mixing nozzle according to at least one of the implementations described herein; and

FIG. 9 is a schematic diagram of an upper, perspective cut-away view of the mixing nozzle of FIG. 8 and according to at least one of the implementations described herein.

### DETAILED DESCRIPTION

The following detailed description includes example implementations that are not intended to limit the subject matter of the application and uses thereof. Furthermore, there is no intention to be bound by any theory presented in the preceding background, brief summary, or the following detailed description.

Conventional injection mixing nozzles that receive component chemicals and discharge a mixed stream typically provide excessive or insufficient amount of carrier fluid, such as water for papermaking as one example, and cannot produce a target amount of mixed product. Many of these nozzles are bulky, multi-part systems that unnecessarily add to manufacturing costs of the nozzle and limit the applicability of the nozzle, while other nozzles are generic or multi-use mixing nozzles that are not tuned for particular fluid properties. As a result, many of the known mixing nozzles cannot produce a mixed stream with desired properties such as the amount of mixed product, energy, flow-rate, and pressure of the discharged mixed stream, thereby resulting in increased costs and failure in performance. Yet some other nozzles that acquire target fluid properties require the injected fluid components to have extremely large amounts of input energy, thereby prohibiting the use of such nozzles in many environments in the first place.

To resolve these problems, the present mixing nozzle uses a swirl or vortex chamber to generate the desired energy, velocity, flow-rate, and pressure for one of the chemical components to be subsequently mixed with one or more other chemical components and to adequately and efficiently generate a mixed product for a discharged mixed stream. The vortex creates a desired (1) conservation of angular momentum to increase fluid velocity, (2) pressure differential to increase the flow-rate and direct more fluid toward a subsequent mixing zone, (3) energy transfer from potential to kinetic energy that results in more vigorous interactions between the component chemicals, and (4) concentration of flow which also can lead to higher energy and increased turbulence for thorough mixing. By leveraging these mechanisms, the vortex can significantly improve the efficiency of subsequently mixing the chemical components, better ensuring that the chemical components are well combined.

As another feature, a core may be provided in the middle of the vortex chamber to enhance mixing, stabilize the swirling flow pattern around the core with better control of flow dynamics or more precisely, the velocity and pressure profiles within the vortex. This can lead to more uniform mixing and improved reaction rates. The core also may focus energy to enhance the velocity of the fluid as it moves inward and exits at higher speeds, which aids in mixing. Otherwise, the core itself can reduce or prevent at least some cavitation by maintaining appropriate pressure levels at the sides of the core within the vortex.

It has been found, however, that cavitation can still occur in the vortex chamber. Specifically, a core is placed in the middle of the vortex chamber so that the fluid circulates or spirals around the core until the fluid reaches a space between a free bottom or distal end of the core and the outlet of the vortex chamber. In this case, cavitation can still occur in this location within the vortex chamber, thereby still reducing flow-rate, velocity, pressure, and energy below target levels, resulting in inadequate mixing in subsequent mixing chambers of the mixing nozzle.

On the present mixing nozzle disclosed herein, the vortex chamber is self-regulating or self-equalizing so that cavitation below the core is reduced or eliminated by placing a core channel through the core so that fluid entering the vortex chamber from a sidewall of the vortex chamber, crosses the vortex chamber and enters an entrance of the core channel. The core channel then has a channel exit that directs the fluid downward toward the outlet of the vortex chamber and through the area that is susceptible to cavitation. By one form described herein, the fluid flowing through the core channel is the same fluid whirling or spinning around the core. To accomplish this, by one example, the channel entrance for the core channel is placed at least partly within the flow path of the fluid entering through an inlet opening on a sidewall or side surface of the vortex chamber.

The vortex chamber outlet communicates with at least one subsequent mixing section of the nozzle that receives at least a second fluid to mix with the first fluid from the vortex chamber. The mixing section also may have one or more mixing chambers that have features to enhance mixing of the chemical components as well, including a flat perpendicular surface defining the inlet for the fluid from the vortex chamber and into the mixing chamber. This creates eddies extending in a longitudinal direction in the mixing chamber for better mixing with the second fluid.

Also with regard to the mixing chambers, and in one particular example when the first fluid is a carrier and the second fluid is a papermaking additive as one example, performance of such chemical additives, such as strength aids, retention aids, etc. in a papermaking process depends on the distribution and adsorption of these additives, such as onto a cellulosic material as one example. In many cases, these additives react with and/or adsorb on contact with the first surface compatible with the additive, including molecular surfaces. Due to this immediate reaction to surfaces, mixing in a controlled and timely manner is desired for the additives. Thus, the present mixing nozzle also has the one or more of the mixing chambers sized and dimensioned with a length (or height) along a flow path through the nozzle to provide a target interaction time that is a duration the fluids or chemical components are in contact for more productive and efficient mixing.

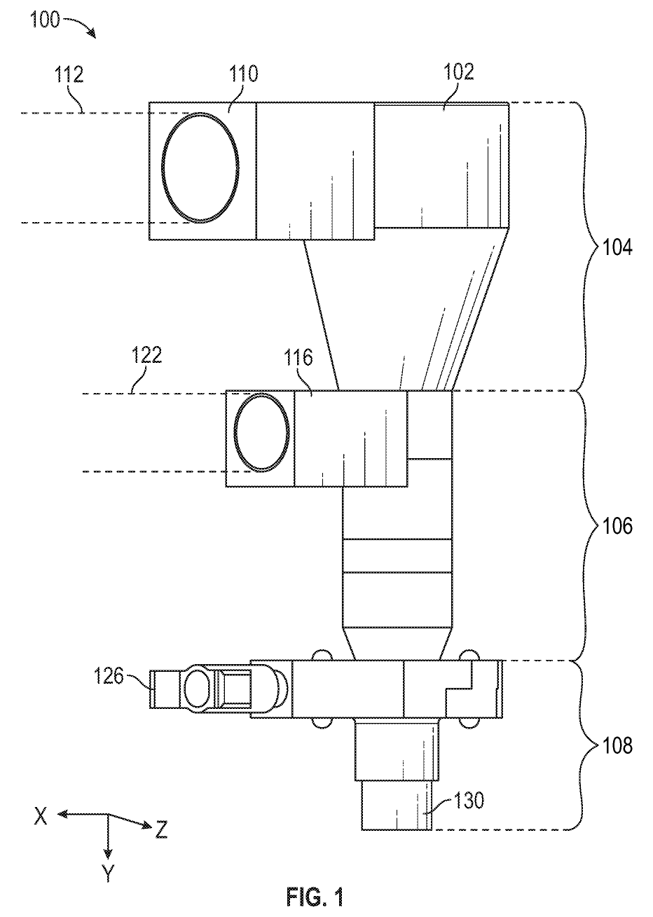

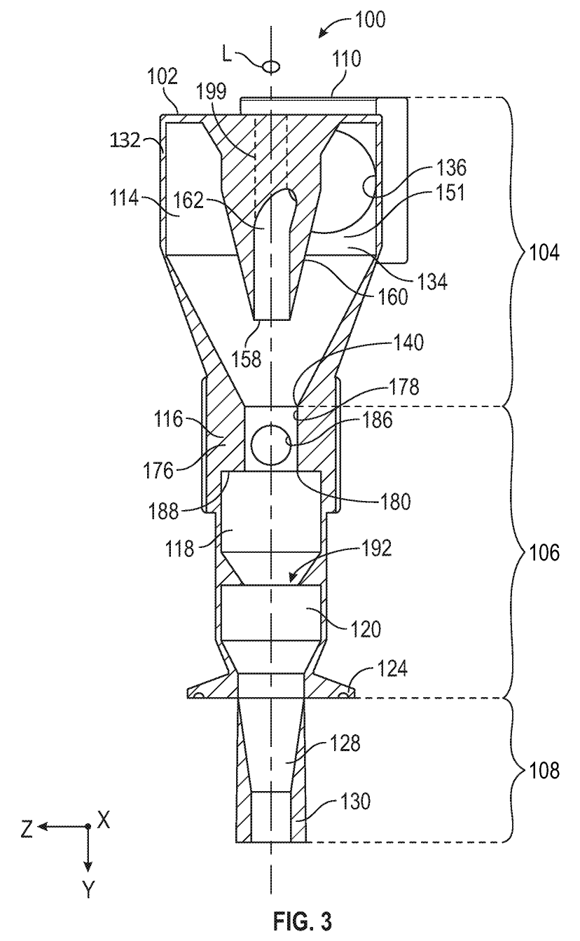

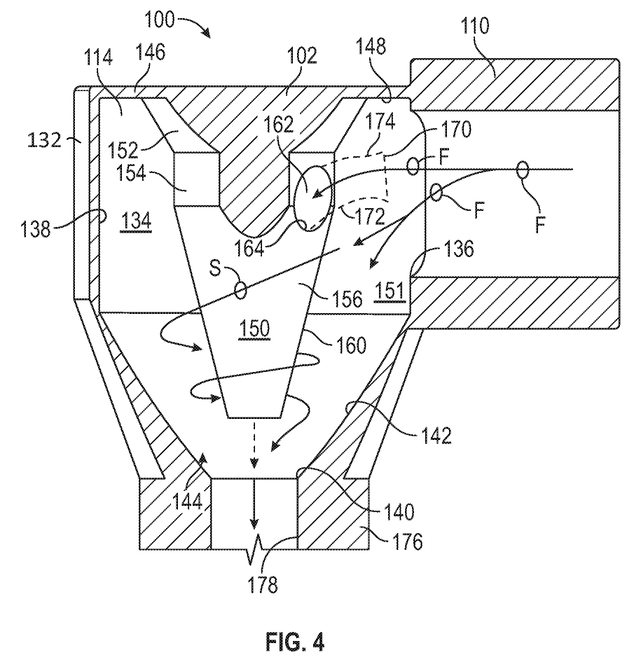

Referring to FIGS. 1-4 now for more detail, an example mixing nozzle 100 has a body 102 with a swirling or vortex section 104, a mixing section 106, and a discharge section 108. A main feed (or main or first feed conduit) 110 is attached to the vortex section 104 and receives a first fluid, such as a carrier fluid by one example, from a first feed or injection line 112 and fluidly communicates with a vortex chamber 114 (FIGS. 3-4) in the vortex section 104 to provide the first fluid to the vortex chamber 114. A secondary (or additive) feed or feed conduit (or second feed conduit) 116 is attached to the mixing section 106 and fluidly communicates with at least one mixing chamber (here two are shown 118 and 120, FIG. 3) at the mixing section 106 to provide a second fluid or additive to mix with the first fluid after the first fluid is received from the vortex chamber 114. A second injection line 122 feeds the second fluid to the second feed conduit 116. The resulting mixed product in a mixed stream is then discharged from the nozzle 100 through the discharge section 108 to downstream pipes, including a process pipe, or fluid delivery devices (not shown) carrying and further treating the mixed stream.

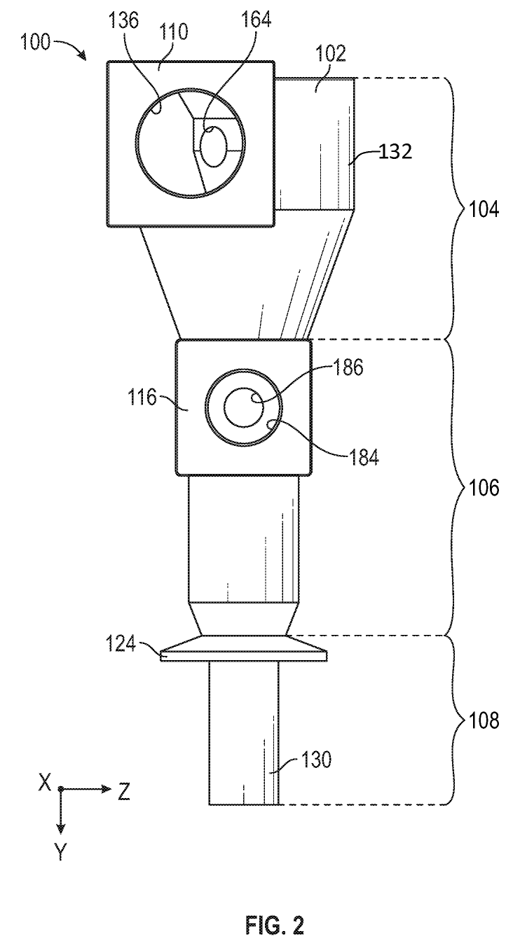

The nozzle 100 may have one of more suitable flanges 124 (FIG. 2) to mount the nozzle on a base, conduits, or other devices to fix or stabilize the position of the nozzle 100, such as use of a locking collar 126 (FIG. 1) to hold the nozzle. Likewise, the nozzle 100 may have fittings (not shown), such as sanitary fitting as one example, at the ends of the first and second feed conduits 110 and 116 and at an end of the discharge section 108 (not shown) to attach to other pipes, conduits, devices, or lines as mentioned. By one example, the flanges enable connection to flanged adapters welded to process pipe surfaces. Any suitable mounting structure can be used, and no particular limit exists as to the mounting structures to hold the nozzle 100.

By one example form, the nozzle 100 may be held in any 360 degree or 3D position. In this case, the fluid flow rate and pressure, as well as other fluid properties, are sufficiently strong to form a forced flow such that gravity is not a significant force in the fluid flow through the nozzle, although it will be appreciated that fluid properties may be set at a weaker level so that gravity is used to define a fluid flow path. In the example shown, the vertical pose of the nozzle 100 in the figures has an elongated direction of the nozzle 100 that extends vertically along a longitudinal axis L (FIG. 3) of the nozzle 100 and is one of many example orientations for use of the nozzle 100. By one example, orienting the nozzle 100 at a certain angle relative to a process pipe may be desirable such as when positioning the nozzle perpendicular to the process flow may be used to penetrate the injected stream farther into process flow stream, versus as angled entry to deliver an injected stream into the outer portion of the process flow in the process pipe.

Also, it should be noted that the terms horizontal/vertical, top/bottom, upper/lower, above/below, and so forth used to describe parts of the nozzle 100 anywhere herein refer to the position of the parts relative to each other and not to the ground.

With regard to the first and second feed conduits 110 and 116, it will be appreciated that other feed conduit arrangements may be used instead. Thus, two or more conduits may provide fluids directly to the vortex chamber 114 in the vortex section 104, whether on a side of the vortex chamber 114, from the top of the vortex chamber 114, or any other injection orientation. Thus, any suitable number of feed conduits may be directed to the vortex chamber as long as one of the feed conduits provides fluid in a tangential manner relative to the vortex chamber 114 to generate the whirling or spinning motion of the fluid vortex. By one form, each conduit provides a different fluid of a different chemical, or any combination of the feed conduits may provide the same fluid with the same chemistry. By one example herein, the single feed conduit 110 provides a carrier fluid such as carrier water into the vortex chamber 114.

Also, the nozzle 100 may have one mixing chamber instead of two mixing chambers as shown, or may have more than two mixing chambers. By one form, none of the mixing chambers receive a second fluid directly and any introduction of multiple fluids occurs at the vortex chamber or below the vortex chamber at one of more junction portions described below. Otherwise in other alternatives, each mixing chamber may have a feed conduit feeding a fluid directly into the mixing chamber, or externally but near an inlet of the mixing chamber, and that is to be mixed with the first fluid from the vortex chamber. As other alternatives, more than one feed conduit may provide fluid to a single mixing chamber, a portion of the mixing chambers, or all of the mixing chambers, whether the same fluid already introduced previously or different fluids in each feed conduit. Many variations are contemplated. By one form, the second feed conduit 116 provides an additive that is mixed with the carrier water from the vortex chamber 114 in the mixing chambers 118 and 120 for a papermaking process.

Regarding the discharge section 108, which also may be considered a nozzle, the discharge section 108 may have any suitable and desired flow control parts to control the flow-rate, velocity, pressure, and other fluid properties of the mixed stream being discharged from the nozzle 100. This may include performing additional mixing of the fluids within the discharge section 108. By the present example, the discharge section 108 may have a contraction or funnel portion 128 and a cylindrical portion (or outlet conduit) 130 (FIG. 3). The outlet conduit 130 may connect directly to a mixed stream (or process) pipe (not shown) or may connect to one or more fittings or adapters that in turn connects to a process pipe. The outlet conduit 130 may attach to processing pipe by welding or any other suitable method. By another form, a cylindrical portion of the outlet conduit 130 is generally over-sized (in length) such that it will extend into the process pipe. Once the nozzle is installed, the excess portion inside the pipe is ground flush to prevent protrusions into the pipe (i.e., reducing flow obstructions). This allows a one-size approach that is fit in place on install.

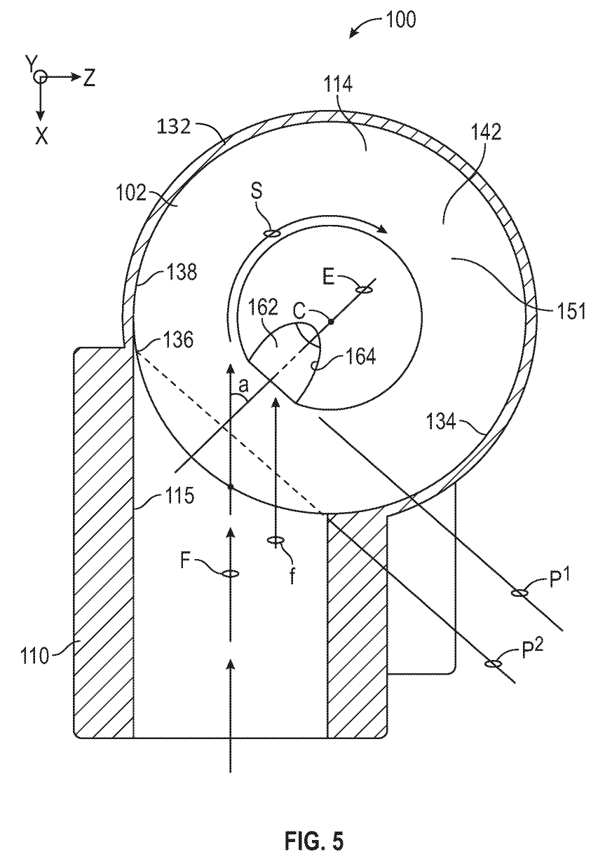

Referring to FIGS. 4-5, the vortex chamber 114 is a self-balancing (or self-equalizing) vortex chamber that reduces or eliminates cavitation near the outlet 140 of the vortex chamber114. Specifically, the vortex section 104 of the body 102 has a sidewall 132 with a circular or cylindrical inner surface 134 (in top view (FIG. 5)) that defines the vortex chamber 114 and defines at least one inlet opening 136 to the vortex chamber 114 that provides the first fluid from the first feed conduit 110. The inlet opening 136 and feed conduit 110 define a flow-direction or axis F. The flow direction F is laterally spaced from a middle area or center C of the vortex chamber 114 so that the flow direction F is tangential to a spiraling flow direction S around the center C in top view (FIG. 5). Also, the feed conduit 110 may have an outer wall 115 tangential to the inner surface 134 so that flow entering the vortex chamber 114 from the feed conduit 110 will be further directed to swirl around the center C of the vortex chamber 114.

Longitudinally, the inner surface 134 in this example has a cylindrical portion 138 and a conical or funnel portion 142, which may be frustoconical (or a truncated cone), below the cylindrical portion 138 and that reduces in diameter as the conical portion 142 extends downward. The sidewall 132, and in turn inner surface 134, define an outlet 140 of the vortex chamber 114, and the conical portion 142 reduces in diameter to the outlet 140. By one example form, the outlet 140 is at a bottom 144 of the vortex chamber 114.

The vortex chamber 114 also has an upper wall 146 with a downwardly or inwardly facing upper surface or ceiling 148 that defines a top of the vortex chamber 114. For the reasons explained above, a fluid directing core 150 is placed centrally within the vortex chamber to form an annular space 151 between the core 150 and the inner surface 134. By one example, the core 150 extends downward from the upper surface 148, and by one form may be integrally formed with the upper wall 146. By one example form, the core 150 hangs downward (or inward) along axis L from the upper surface 148 and attaches (or is integrally formed with) the upper wall 146 without other supports. By other alternatives, the core 150 may have other supports such as braces. By one form, the core 150 is generally conical. In one specific example, the core 150 may be cylindrical or conical. In the present example, the core 150 has a base conical portion 152, a middle cylindrical portion 154, and a distal cone (or conical) portion 156 that reduces in diameter as it extends downward toward the outlet 140. The distal cone portion 156 is truncated at the end of the core 150 to provide a channel exit 158 as explained below whether the truncation is perpendicular or at a non-perpendicular angle to axis L. The core 150 has an outwardly facing core surface 160 spaced from, and facing, the inner surface 134 to define the annular space 151 of the vortex chamber 114 between the core surface 160 and the inner surface 134. The core 150 assists with inducing a swirling flow from the feed conduit 110 and along flow path F is forced to travel around the core 150.

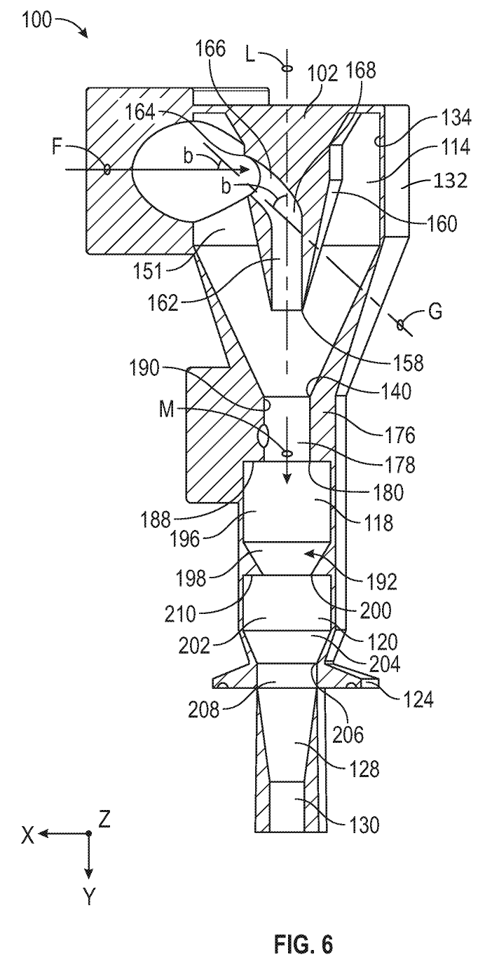

Referring to FIG. 6, the core 150 also has a core channel 162 extending through the core 150 and that has at least one channel entrance 164 and at least one channel exit 158. The channel entrance 164 here is disposed at least partially within the flow path F and across the annular space 151 of the vortex chamber 114 from the inlet opening 136 so that the channel entrance 164 faces the inlet opening 136 (FIG. 4).

Referring to FIG. 4, the channel exit 158 fluidly communicates with the vortex chamber 114 and faces the outlet 140 of the vortex chamber 114. By one form, the core surface 160 at the conical portion 156 forms a truncated cone with the channel exit 158 forming at least part of a truncated plane of the truncated cone and facing toward the outlet 140 of the vortex chamber 114. Fluid entering the channel entrance 164 from the flow path F (or more specifically a part f of the flow path F intersecting the channel entrance 164) and then exiting the channel 162 through the channel exit 158 recombines with the fluid from the core channel 162 below the core 150 near the bottom 144 of the vortex chamber.

By one example form, the channel entrance 164 is a hole in the core surface 160 spaced apart from (or opposing) the inlet opening 136 of the vortex chamber 114. By one example form, it can be seen that the channel entrance 164 is entirely within a horizontal projection or profile (FIG. 2) of the inlet opening 136 and the feed conduit 110 and projected in the direction of the feed conduit axis or direction of flow F to the core 150. Referring to FIG. 5 again as another example, the channel entrance 164 faces radially outward from the core 150 and forms a channel entrance flow path axis E that is transverse to the feed conduit axis F. By the present example, the channel entrance flow path axis is angled with an exterior angle a of about 45 degrees in top view from the feed conduit axis F, although many other angles may be used. By another form, the channel entrance 164, and precisely the face of the channel entrance 164, may extend parallel to the inlet opening 136 on the sidewall 132. This is shown by parallel lines p1 and p2 on FIG. 5.

By other options, the channel entrance 164 may even face away from the inlet opening 136 so that fluid swirling to a different opposite side of the core 150 than that of the inlet opening 136 still may receive fluid form the annular space 151 as well. This may occur to due to the relatively strong fluid pressure or the filling of the vortex chamber. In this case, the flow path F (and/or direct flow path f) is considered to extend around the core.

Referring again to FIG. 6, the core channel 162 may be nonlinear so that the channel exit 158 faces downward toward the outlet 140 of the vortex chamber 114 at a vertical angle to a direction of the fluid flow from the inlet opening 136 to the channel entrance 164. In one example, fluid flow direction F is (vertically) perpendicular to the longitudinal axis L, and the core channel 162 is bent to have an entrance portion 166 with a central axis (or flow direction) G at an angle b of about 45 degrees from both the flow direction F and the longitudinal axis L, although the angle may be different from each and other than 45 degrees. Thus, the core channel 162 has interior walls 168 that define the core channel 162 and that are (vertically) nonlinear as the core channel 162 extends toward the outlet 140 and curves to position the channel exit 158 to face toward, and oppose, the outlet 140. It will be understood, however, the interior channel walls may have many different shapes and arrangements as long as the channel entrance 164 and channel exit 158 are positioned as described herein and friction loss due to the interior channel walls 168 is factored to determine the desired pressure and velocity of the first fluid exiting the channel exit 158.

With this arrangement, cavitation is reduced by using the first fluid or chemical component (or carrier, e.g., water) from the first feed conduit 110 to both form the vortex and flow through the core channel 162 so that the vortex chamber 114 is self-balancing or self-equalizing (or self-regulating). Specifically, with the position of the channel entrance 164 as described above, the core channel 162 may divert some of the first fluid from flow path f from the first fluid conduit 110 and inlet opening 136 into the channel entrance 164 and out of the channel exit 158. The remainder of the first fluid follows flow path or directions F and S to swirl around the core 150. The first fluid then recombines below the channel exit 158 and above the outlet 140 at the bottom 144 of the vortex chamber 114, thereby causing turbulence and re-direction of the horizontally rotating first flow, and redirected downward toward the outlet 140. While the greater the injected flow rate of the first fluid into the vortex chamber 114, the greater the pressure drop at the bottom 144 of the vortex chamber 114, the core channel 162 now reduces or eliminates that pressure drop with self-provided fluid pressure.

In one specific example form for papermaking, where the first fluid comprises water as a carrier, a cylindrical diameter of the vortex chamber may be 64 mm, while the first fluid conduit has an inner diameter of about 32 mm (1.25 inches). In this example, the core may have an upper end at the base conical portion with a 42 mm diameter and height of about 11 mm, while the cylindrical portion has a 15 mm diameter and a height of 10 mm, and the conical portion reduces from the 15 mm diameter to 2 mm to 12 mm as one example, and by one particular example 10 mm, at the channel exit. The longitudinal length of the conical portion is 40 mm. By one example, the core channel has an inner diameter of about 10 mm. The bottom tip of the core is about 9.5 mm from the outlet at the bottom of the vortex chamber. These are merely one example of dimensions that may be used, and it will be understood that many different dimensions and arrangements may be used.

Referring again to FIG. 4 for another alternative approach, a channel entrance 170 may be formed of a tube 172 connected to the core 150 and extending the core channel 162 outwardly from the core 150 to form an extension entrance portion 174 of the core channel 162. This places the channel entrance 170 at or near the inlet opening 136, or even within the feed conduit 110. The channel exit 158 may be extended as well, and by one example as long as sufficient recombination mixing can occur with swirling fluid to sufficiently reduce cavitation.

As yet another alternative, the core 150 may have a channel 199 (FIG. 3) that extends through the upper wall 146 so that the first fluid (or carrier) can be received through the channel 199 in addition to, or instead of, through the conduit 110 and inlet opening 136.

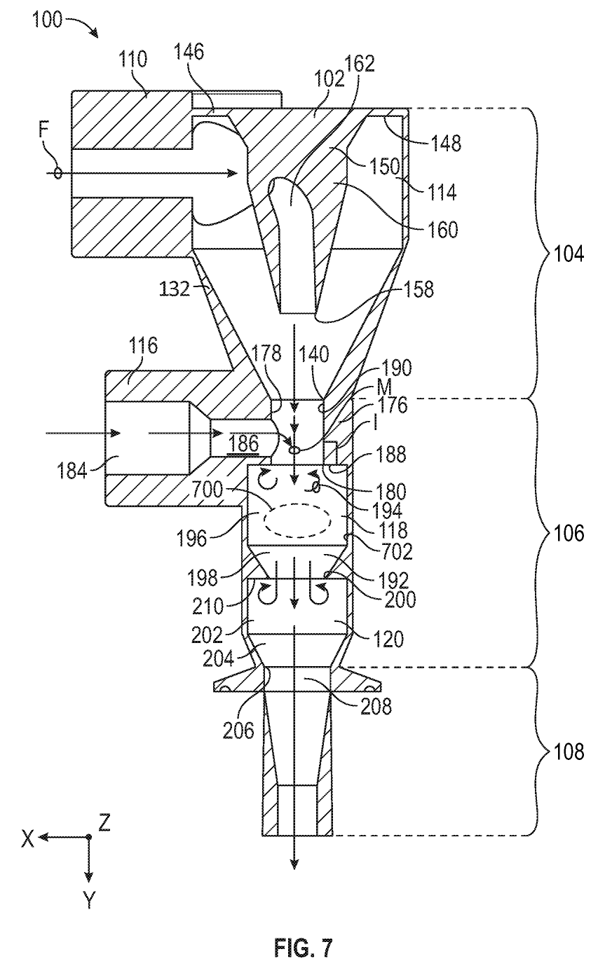

Referring to FIGS. 3 and 7, the mixing section 106 has a junction portion or block 176 below the vortex chamber 114 to receive the first fluid from the outlet 140 of the vortex chamber 114. The junction portion 176 may be formed by sidewall 132 or may be considered to be integrally formed with the sidewall 132. The junction portion 176 has a passage 178 that fluidly communicates with the vortex chamber 114 and vortex chamber outlet 140. A passage outlet 180 of passage 178 is also a mixing chamber inlet to first mixing chamber 118. The junction portion 176 includes a portion 186 of the second feed conduit 116 to receive the second fluid. Thus, the first and second fluids initially contact within the passage 178, and then begin mixing as the combining fluids are directed downward by the downward flow of the first fluid within passage 178 to the upper most or first mixing chamber 118 closest to the vortex chamber 114. As mentioned for the papermaking industry, while the first fluid is a carrier, the second fluid may be an additive, but otherwise may be many different chemicals described below instead.

The second feed conduit 116 may have an upstream wider portion 184 that constricts to the downstream narrower portion 186 to increase the velocity of the second fluid. By one present example, the wider portion 184 may have a 25.4 mm (one inch) inner diameter, while the narrower portion 186 contracts to an inner diameter of about 8 to 25.4 mm prior to being introduced into the flow region of the passage 178 carrying the first fluid.Also in the present example, the passage 178 of the junction portion 176 may have an inner diameter of 14 to 22 mm, and in one form 16 mm diameter. The longitudinal length may be 20 mm as one example. By one form, the second fluid conduit 116 is perpendicular to the passage 178 to form a horizontal T-junction here, although the second feed conduit 116 may attach to the passage 178 at different angles.

As mentioned, the mixing section 106 of the body 102 may have at least one, and here two, mixing chambers 118 and 120. The mixing chambers 118 and 120 may have many different shapes and arrangements than shown as long as the mixing chambers induce further mixing.

Referring again to FIGS. 6-7, and by one alternative arrangement for a mixing chamber (or each mixing chamber) 118 for example, the mixing chamber 118 has a substantially flat mixing chamber (MC) inlet surface 188 defining the inlet (or inlet opening) 180. In this example, the MC inlet surface 188 extends perpendicular to a wall 190 defining passage 178 and/or a general flow direction M defined by the passage 178. The passage wall 190 may be cylindrical. Thus in this case, the MC inlet surface 188 may be at an interior angle I of 90 degrees or less with the flow direction M and/or passage wall 190. Another way to describe this is that the MC inlet surface 188 is either perpendicular or tapers outward away from a middle or bottom portion 192 of the mixing chamber 118, but does not taper toward the middle or bottom portion 192 of the mixing chamber 118.

The general arrangement of the features of mixing chamber 118 described above provides a zone of immediate expansion within the mixing chamber 118, which creates a low pressure pulse along the flow path that assists in easing the forces of the swirling flow from obstructing the introduction of the second fluid additive in the passage 178. The immediate expansion also then results in the flow entering the mixing chamber 118 in eddies shown by arrows 194 and that increases the speed of the mixing. These eddies are vertical (“y-axis” or longitudinal direction) eddies at the upper edges of the mixing chamber 118 to enhance the mixing. By one example form, when the diameter or width of the mixing chamber inlet 180 is from 14 to 20 mm, the outer diameter or width of the mixing chamber 118, and in turn the MC inlet surface 188, may be 30 mm.

As best seen in FIG. 6, the mixing chamber 118 may have an upper cylindrical portion 196 where the MC inlet surface 188 forms a top of the cylindrical portion 196. A middle or bottom portion192 of the mixing chamber 118 is conical or funnel shaped to form a constriction down to an outlet 200 of the mixing chamber 118. By one example form, the conical portion 198 tapers in diameter from 30 mm down to from 14 to 22 mm, and by one form 16 mm, at the outlet 200 of the mixing chamber 118, and may be 10 mm in height as one example.

Referring to FIGS. 6-7, and as mentioned, one or more mixing chambers may exist, and here the second mixing chamber 120 receives the mixing fluid from the first mixing chamber 118 so that the outlet 200 of the mixing chamber 118 is the inlet of the mixing chamber 120, although other configurations and separation of the inlet to mixing chamber 120 and outlet 200 may be used. Also, the mixing chamber 120 has many of the same or similar features as mixing chamber 118 such that the descriptions of those features need not be repeated in detail. Thus, the second mixing chamber 120 has an upper surface 210 defining the mixing chamber inlet 200 that also is the outlet 200 of the upper mixing chamber 118. The mixing chamber 120 has an upper cylindrical portion 202 and a lower conical portion 204, e.g., in a configuration similar to that of mixing chamber 118 described above. The upper or inlet surface 210 provides eddies as explained above with respect to MC inlet surface 188. By one form, the additional mixing chamber 120 increases the uniformity of the resulting mixed product in a discharged mixed fluid stream.

By applying the second fluid, such as an additive, to a select region and specific application point on the nozzle 100, the interaction time can be carefully controlled by setting the flow direction length (or longitudinal or y-direction length, relative to the figures herein) over which the fluids will be in forced contact. This may include setting the lengths (or heights) of at least the passage 178 and the mixing chambers 118 and 120 along axis L. When mixing is to continue into the discharge section 108, then the heights of the cylindrical portion 208, contraction portion 128, and outlet conduit 130 are set to provide adequate total intermixing duration as well. The shapes and size of those components will affect the interaction time as well. This can result in additional efficacy, elimination or reduction of wasted additive that is deposited on conduit walls, and relative over-treatment due to non-optimized additive distribution in the process stream.

By controlling the interaction time, the nozzle may enable different chemical combinations such as incompatible chemistries or additives for the first and second (or more) fluids as described below. With the present nozzle 100, two incompatible fluids can be mixed inside the nozzle 100, and the interaction time can be set and maintained at a certain duration (not too long or too short) so that the effect of the two incompatible fluids have on each other is minimal and negligent, or otherwise compensated.

Thus, with this arrangement, the length or distance to be set to control the interaction duration for the current example nozzle 100 may be from junction portion 176 of the second feed conduit 116 with the passage 178 and down to either a bottom of the lowest mixing chamber 120 when mixing is to be sufficiently complete by then, but otherwise down through the outlet conduit 130 of the discharge section 108 as mentioned. This distance may be from 92mm to 160mm. The output fluid from the lowest mixing chamber 120 may flow through a cylindrical portion 208 and may be the first part of the discharge section 108.

Referring again to FIG. 7 for another alternative example, further mixing may be achieved by using at least one internal mixer member 700 in at least one of the mixing chambers 118 and/or 120 in this example (shown here only in mixing chamber 118). The mixing member 700 may be positioned near a middle of the mixing chambers 118 and/ 120 or any other desired position. The mixing member 700 may be static and fixed to a sidewall 702 of the mixing chambers 118 or 120 or me be dynamic and free to move, such as rotate, within the mixing chambers 118 and/or 120. In the present example, the mixing member 700 may be a flat plate of any desired shape, and this case, a circular or coin shaped mixing member 700 that rotates within the mixing chamber when impacted by fluid flow from the passage 178. Whether the mixing member 700 is static or dynamic, by one form the mixing member is distinct from the sidewalls 702 of the mixing chambers 118 and/or 120. By other forms, a static mixing member may have a helical shape, and or any other suitable shape, position, and orientation as desired, and may be formed of one-piece or be made of multiple pieces assembled together to form the mixing member 700.

The nozzle 100 may be used to mix many different chemicals in many different industries. The first fluid from the first feed conduit 110 and the second fluid from the second feed conduit 116 may be provided in various ratios and may have chemicals that are oppositely charged or similarly charged, have different molecular weights and/or viscosities, and may include solids as long as a suitable flow can be established. Also, the chemicals may or may not be reactive with each other, for example may be a cationic chemical, such as a flocculent, and anionic chemicals. Also, chemicals such as a micro polymer or anionic microparticles may be used. Co-fed incompatible or different additives may be used that include coacervates (such as carboxymethyl cellulose and polyamidoamine epichlorohydrin), oppositely charged polyelectrolytes, functional additives, and substrate modifiers (such as a process or functional additive and pH, charge, conductivity, or other control additives), polymeric additives with different molecular weights, bonding and debonding additives, and hydrophobic and hydrophilic additives.

Otherwise, as mentioned above, when the interaction time or contact time between the chemicals to be mixed is carefully controlled and set to be a target duration, then chemical combinations can be used that improve additive performance or provide additive properties finished product properties. This may include application of either compatible and incompatible chemistries through the nozzle. This may include chemical additives such as cationic, anionic, amphoteric polymeric additives, or a combination of these. The polymeric additives can come in the form of emulsions, dispersions, solutions, or as dry material. These additives can be added at any ratio or sequence, and these additives can improve the functional properties of the finished product, or the additives can also aid during paper-making processes as one possible example. The additives can be mixed before or during application, and the additives can be added at any location at the wet end of paper machine, as one example. By other examples, incompatibility of the chemicals may be controlled for such mixes. In some of these examples, the chemicals may include coacervate formation prior to application. This may include some of those mentioned above such as the cationic and anionic strength additives, here being wet strength resin and dry strength resins, utilization of incompatible pH carrier fluid to alter the process substrates to allow better performance of the additive, co-feeding compatible additives in a manner which delivers performance beyond the expected additive gains, and so forth. It also will be understood that a single fluid delivery system may have multiple nozzles to perform the mixing where each nozzle mixes the same chemicals or same chemical proportions, or has one or more nozzles mixing different chemicals and/or chemical proportions.

As to the manufacturing of the mixing nozzle itself, a 3D printing process may be used to manufacture the mixing nozzle as one-piece where the parts of the mixing nozzle, such as with the parts of nozzle 100, are integrally formed together as a homogeneous, uniform material, but may be intentionally non-uniform to provide different strengths at different sections of the nozzle and so forth when desired. As one example, additive manufacturing may be utilized, e.g., as carried out with a 3D printer, to fabricate the mixing nozzle as a single piece (i.e., unitary design) via layer-by-layer additive process, allowing for complex geometries that integrate all necessary chambers without seams or joints. Materials of the disclosed nozzle may include high-strength thermoplastics such as Acrylonitrile Butadiene Styrene (ABS) or nylon for their durability and chemical resistance, as well as Polyethylene Terephthalate Glycol (PETG) or Thermoplastic Polyurethane (TPU). In some cases, metal 3D printing may be employed using stainless steel or aluminum alloys for high-pressure applications, or any other suitable metal, alloy, steel, and so forth.

Otherwise, the mixing nozzle may be manufactured with one or more separate parts whether by 3D printing or other processes such as injection molding, computer numerical control (CNC) machining, casting, extrusion, stamping, laser cutting, and so forth. This may include providing nozzles of any desired and suitable material including those mentioned above.

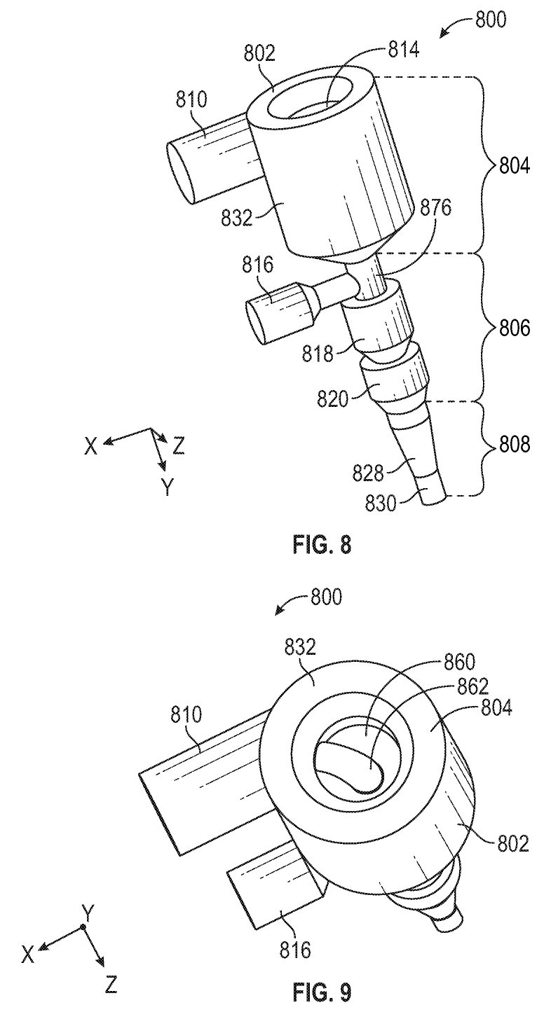

Referring to FIGS. 8-9, an alternative mixing nozzle 800 has a contoured body 802 that better shows the profile of the individual chambers within the nozzle 800. Those parts of nozzle 800 that are similar or the same as on nozzle 100 are numbered similarly. For example, the mixing nozzle 800 has a vortex section 804, mixing section 806, and discharge section 808. A first feed conduit 810, such as for a first fluid that may be a carrier such as water, is connected to a vortex sidewall 832 to provide the first fluid to vortex chamber 814 that is the same or similar to vortex chamber 114, This includes achieving reduced cavitation between a core and a vortex chamber outlet (not shown). The top of the vortex section 804 is shown in see-through so that the interior of the core 860 is shown with the core channel 862 that receives first fluid as well. The first fluid from the vortex chamber 814 then initially contacts a second fluid from a second feed conduit 816 in a passage in a junction portion 876. The mixing fluid then passes into at least one mixing chamber 818 and 820 with eddy and mixing control as mentioned above for mixing chambers 118 and 120. The mixed stream is then discharged through the contraction portion 828 and outlet conduit 830.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements or parts of the nozzle do not imply that a direct physical connection must be made between these elements, unless mentioned otherwise. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention. Finally, while the appended claims recite certain aspects believed to be associated with the invention, they do not necessarily serve as limitations to the scope of the invention.

What is claimed is:

1. A fluid mixing nozzle, comprising:
a body having a sidewall with an inner surface defining a vortex chamber, wherein the inner surface defines an inlet opening having a flow path of a first fluid entering the vortex chamber through the inlet opening, and wherein the body forms an outlet of the vortex chamber;
a core disposed within the body and forming an annular space within the vortex chamber, wherein the core comprises an outwardly facing core surface spaced from, and facing, the inner surface to define the annular space between the core surface and the inner surface;
a core channel extending through the core and having at least one channel entrance and at least one channel exit, wherein the at least one channel entrance is disposed at least partially within the flow path, and wherein the at least one channel exit fluidly communicates with the vortex chamber; and
a mixing section defined by the body and having a first fluid inlet fluidly communicating with the outlet and at least one second fluid inlet to provide a second fluid within the mixing section.

2. The nozzle of claim 1, wherein the channel entrance is a hole in the core surface and is spaced apart from the inlet opening by the annular space in the vortex chamber, and wherein the channel entrance is facing the inlet opening.

3. The nozzle of claim 2, comprising a feed conduit extending horizontally and tangential to the vortex chamber and defining a feed conduit axis parallel to the feed conduit, and wherein the channel entrance is facing radially outward from the core and forms a channel entrance flow path axis that is horizontally transverse to the feed conduit axis.

4. The nozzle of claim 3, wherein the channel entrance flow path axis is angled horizontally about 45 degrees from the feed conduit axis.

5. The nozzle of claim 3, wherein the channel entrance is entirely within a horizontal projection of the inlet opening at the inner surface of the feed conduit and projected parallel to the feed conduit axis.

6. The nozzle of claim 1, wherein the channel entrance extends parallel to the inlet opening on the sidewall.

7. The nozzle of claim 1, wherein the core surface reduces in diameter as the core surface extends toward the outlet of the vortex chamber.

8. The nozzle of claim 1, wherein the core surface is at least partially conical, and the core forms a truncated cone with the channel exit forming at least part of a truncated plane of the cone and facing toward the outlet of the vortex chamber.

9. The nozzle of claim 1, wherein the core channel comprises walls that are nonlinear as the core channel extends toward the outlet and curves to face the channel exit toward the outlet.

10. The nozzle of claim 1, wherein the core generally extends vertically along an elongated longitudinal axis of the nozzle, and wherein the core channel is vertically bent about 45 degrees.

11. The nozzle of claim 1, wherein the channel exit is at the bottom of the core and faces downward toward the outlet of the vortex chamber.

12. The nozzle of claim 1, wherein the body is formed as one-piece.

13. A mixing nozzle device, comprising:
a body having a sidewall with an inner surface defining a vortex chamber, wherein the inner surface defines an inlet opening having a flow path of a first fluid entering the vortex chamber through the inlet opening, and wherein the body forms an outlet of the vortex chamber;
a core disposed within the body and forming an annular space within the vortex chamber, wherein the core comprises an outwardly facing core surface spaced from, and facing, the inner surface to define the annular space between the core surface and the inner surface;
a core channel extending through the core and having at least one channel entrance and at least one channel exit, wherein the at least one channel entrance faces sideways toward the inlet opening and is disposed at least partially within the flow path and across the annular space from the inlet opening, wherein the core channel curves to point the channel exit downward, and wherein the at least one channel exit fluidly communicates with the vortex chamber; and
a mixing section defined by the body and having a first fluid inlet fluidly communicating with the outlet and at least one second fluid inlet to provide a second fluid within the mixing section.

14. The device of claim 13, wherein the inlet opening is a first inlet opening, and wherein the body comprises an upper surface above the inner surface to define the vortex chamber, and wherein the inner surface or upper surface or both define one or more third inlet openings each providing a third fluid to the annular space of the vortex chamber or the core channel.

15. A fluid delivery and mixing system, comprising:
at least first and second feed conduits providing first and second fluids respectively to be mixed;
a nozzle with a body having a sidewall with an inner surface defining a vortex chamber, wherein the inner surface defines an inlet opening of the first feed conduit and having a flow path of the first fluid entering the vortex chamber through the inlet opening, and wherein the body forms an outlet of the vortex chamber;
a core disposed within the body and forming an annular space within the vortex chamber, wherein the core comprises an outwardly facing core surface spaced from, and facing, the inner surface to define the annular space between the core surface and the inner surface;
a core channel extending through the core and having at least one channel entrance and at least one channel exit, wherein the at least one channel entrance is disposed at least partially within the flow path, and wherein the at least one channel exit fluidly communicates with the vortex chamber; and
a sidewall of the body defining a mixing section having a junction portion fluidly communicating with the outlet and having at least one second fluid inlet to receive a second fluid within the junction portion.

16. The system of claim 15, wherein the mixing section comprises a mixing chamber and a dividing wall with a fluid passage defining a direction of flow from the outlet of the vortex chamber and to the mixing chamber, and wherein the dividing wall comprises an inlet surface that is a surface of the mixing chamber and defining a mixing chamber inlet fluidly communicating with the fluid passage, and wherein the inlet surface has no more than a 90 degree interior angle relative to the direction of flow.

17. The system of claim 15, wherein the fluids being mixed within the nozzle are at least one of: a carrier and an additive, various ratios, oppositely charged, similarly charged, differing in molecular weights, differing in viscosities, differing in chemicals, incorporating solids, reactive with each other, non-reactive with each other, cationic, flocculents, anionic, amphoteric, micro polymers, anionic microparticles, coacervates, oppositely charged polyelectrolytes, polymeric, varying molecular weights, bonding additive, debonding additives, hydrophobic additive, hydrophilic additive, and incompatible pH carrier fluids.

18. The system of claim 15, wherein the mixing section has at least one mixing chamber passing a fluid therethrough and having interior walls defining the mixing chamber and at least one mixing member disposed within the at least one mixing chamber and that is distinct from the interior walls.

19. The system of claim 15, comprising a tube extending outwardly from the core, fluidly communicating with the core channel, and forming the channel entrance facing the inlet opening.

20. The system of claim 15, wherein the flow path extends to curve around the core and the channel entrance faces a direction away from the inlet opening and on the core.
